(19) United States
(12) Patent Application Publication
(10) Pub. No.: US 2025/0071683 A1
(43) Pub. Date: Feb. 27, 2025

(54) MONITORING METHOD AND APPARATUS, TERMINAL, NETWORK-SIDE DEVICE, AND READABLE STORAGE MEDIUM

(71) Applicant: VIVO MOBILE COMMUNICATION CO., LTD., Dongguan (CN)

(72) Inventors: Dongru LI, Dongguan (CN); Lihui WANG, Dongguan (CN)

(73) Assignee: VIVO MOBILE COMMUNICATION CO., LTD., Dongguan (CN)

(21) Appl. No.: 18/942,885

(22) Filed: Nov. 11, 2024

Related U.S. Application Data
(63) Continuation of application No. PCT/CN2023/092815, filed on May 8, 2023.

(30) Foreign Application Priority Data
May 11, 2022 (CN) 202210515802.0

(51) Int. Cl. H04W 52/02

(52) U.S. Cl. CPC H04W 52/0235

(57) ABSTRACT

This application discloses a monitoring method and apparatus, a terminal, and a network-side device. The method includes: acquiring, by a terminal, first indication information, where the first indication information is used for indicating whether the terminal performs wake-up signal monitoring; and performing, by the terminal, a first behavior when the first indication information indicates that the terminal performs the wake-up signal monitoring, where the first behavior includes: wake-up signal monitoring or a second behavior. The second behavior includes at least one of the following: applying a first power saving mode; suspending sending of first content; suspending receiving or monitoring of second content; turning on a first receiver, where the first receiver is configured to receive the wake-up signal; or entering a first sleep state, where the terminal suspends transmission of a channel or signal in the sleep state.

### CROSS-REFERENCE TO RELATED APPLICATIONS

This application is a continuation of International Application No. PCT/CN2023/092815, filed May 8, 2023, which claims priority to Chinese Patent Application No. 202210515802.0, filed May 11, 2022. The entire contents of each of the above-referenced applications are expressly incorporated herein by reference.

### TECHNICAL FIELD

This application relates to the field of communication technologies, and specifically relates to a monitoring method and apparatus, a terminal, a network-side device, and a readable storage medium.

### BACKGROUND

In mobile communication systems, how terminal power consumption is reduced is a crucial technical issue. However, at present, terminals need to continuously monitor relevant physical channels to know whether a network has data scheduling, so the communication-related modules of the terminals are maintained in a high-power-consumption working state, resulting in a poor power saving effect of the terminals. Therefore, how the power saving effect of the terminals is improved is an urgent problem to be solved at present.

### SUMMARY

Embodiments of this application provide a monitoring method and apparatus, a terminal, a network-side device, and a readable storage medium.

According to a first aspect, a monitoring method is provided. The method includes: acquiring, by a terminal, first indication information, where the first indication information is used for indicating whether the terminal performs wake-up signal monitoring; and performing, by the terminal, a first behavior in a case that the first indication information indicates that the terminal performs the wake-up signal monitoring, where the first behavior includes: wake-up signal monitoring and/or a second behavior. The second behavior includes at least one of the following: applying a first power saving mode; suspending sending of first content; suspending receiving or monitoring of second content; turning on a first receiver, where the first receiver is configured to receive the wake-up signal; or entering a first sleep state, where the terminal suspends transmission of a channel and/or signal in the sleep state.

According to a second aspect, a monitoring apparatus is provided. The monitoring apparatus includes an acquisition module and an execution module. The acquisition module is configured to acquire first indication information, where the first indication information is used for indicating whether a terminal performs wake-up signal monitoring. The execution module is configured to perform a first behavior in a case that the first indication information indicates that the terminal performs the wake-up signal monitoring, where the first behavior includes: wake-up signal monitoring and/or a second behavior. The second behavior includes at least one of the following: applying a first power saving mode; suspending sending of first content; suspending receiving or monitoring of second content; turning on a first receiver, where the first receiver is configured to receive the wake-up signal; or entering a first sleep state, where the terminal suspends transmission of a channel and/or signal in the sleep state.

According to a third aspect, a monitoring method is provided. The method includes: sending, by a network-side device, first indication information, where the first indication information is used for indicating whether a terminal performs wake-up signal monitoring.

According to a fourth aspect, a monitoring apparatus is provided. The monitoring apparatus includes a sending module. The sending module is configured to send the first indication information, where the first indication information is used for indicating whether the terminal performs the wake-up signal monitoring.

According to a fifth aspect, a terminal is provided. The terminal includes a processor and a memory. The memory stores a program or instructions capable of running on the processor, and when the program or instructions are executed by the processor, the steps of the method according to the first aspect are implemented.

According to a sixth aspect, a terminal is provided including a processor and a communication interface, where the processor is configured to acquire first indication information, and the first indication information is used for indicating whether the terminal performs wake-up signal monitoring. The processor is further configured to perform a first behavior in a case that the first indication information indicates that the terminal performs the wake-up signal monitoring, where the first behavior includes: wake-up signal monitoring and/or a second behavior. The second behavior includes at least one of the following: applying a first power saving mode; suspending sending of first content; suspending receiving or monitoring of second content; turning on a first receiver, where the first receiver is configured to receive the wake-up signal; or entering a first sleep state, where the terminal suspends transmission of a channel and/or signal in the sleep state.

According to a seventh aspect, a network-side device is provided. The network-side device includes a processor, a memory, and a program or instructions stored in the memory and capable of running on the processor, and when the program or instructions are executed by the processor, the steps of the method according to the third aspect are implemented.

According to an eighth aspect, a network-side device is provided, including a processor and a communication interface, where the communication interface is configured to send first indication information, and the first indication information is used for indicating whether a terminal performs wake-up signal monitoring.

According to a ninth aspect, a communication system is provided, including a terminal and a network-side device. The terminal may be configured to perform the steps of the monitoring method according to the first aspect, and the network-side device may be configured to perform the steps of the monitoring method according to the third aspect.

According to a tenth aspect, a readable storage medium is provided. The readable storage medium stores a program or instructions, and when the program or instructions are executed by a processor, the steps of the method according to the first aspect or third aspect are implemented.

According to an eleventh aspect, a chip is provided. The chip includes a processor and a communication interface, where the communication interface is coupled to the processor, and the processor is configured to run a program or instructions to implement the method according to the first aspect or third aspect.

According to a twelfth aspect, a computer program/program product is provided. The computer program/program product is stored in a storage medium, and the computer program/program product is executed by at least one processor to implement the steps of the monitoring method according to the first aspect or third aspect.

In an embodiment of this application, a terminal acquires first indication information, where the first indication information is used for indicating whether the terminal performs wake-up signal monitoring; the terminal performs a first behavior in a case that the first indication information indicates that the terminal performs the wake-up signal monitoring, where the first behavior includes: wake-up signal monitoring and/or a second behavior, and the second behavior includes at least one of the following: applying a first power saving mode; suspending sending of first content; suspending receiving or monitoring of second content; turning on a first receiver, where the first receiver is configured to receive the wake-up signal; or entering a first sleep state. In this way, the first indication information indicates whether the terminal performs the wake-up signal monitoring, so that the terminal can selectively perform wake-up signal monitoring according to indication of the first indication information and can also selectively perform other behaviors (such as the foregoing second behavior) during wake-up signal monitoring, thereby further saving power and improving communication power efficiency of a system.

### BRIEF DESCRIPTION OF DRAWINGS

FIG. 1 is a system architecture diagram of a communication system according to an embodiment of this application;

FIG. 2 is a schematic structural diagram of a receiving module of a terminal according to an embodiment of this application;

FIG. 3 is a first method flowchart of a monitoring method according to an embodiment of this application;

FIG. 4 is a second method flowchart of a monitoring method according to an embodiment of this application;

FIG. 5 is a first schematic structural diagram of a monitoring apparatus according to an embodiment of this application;

FIG. 6 is a second schematic structural diagram of a monitoring apparatus according to an embodiment of this application;

FIG. 7 is a schematic structural diagram of a communication device according to an embodiment of this application;

FIG. 8 is a schematic diagram of a hardware structure of a terminal according to an embodiment of this application; and

FIG. 9 is a schematic diagram of a hardware structure of a network-side device according to an embodiment of this application.

### DETAILED DESCRIPTION

The following clearly describes the technical solutions in the embodiments of this application with reference to the accompanying drawings in the embodiments of this application. Apparently, the embodiments described are merely some rather than all of the embodiments of this application. All other embodiments obtained by persons of ordinary skill in the art based on the embodiments of this application shall fall within the protection scope of this application.

The terms “first”, “second”, and the like in the specification and claims of this application are used to distinguish between similar objects rather than to describe a specific order or sequence. It should be understood that terms used in this way are interchangeable in appropriate circumstances so that the embodiments of this application can be implemented in other orders than the order illustrated or described herein. In addition, “first” and “second” are usually used to distinguish objects of a same type, and do not restrict a quantity of the objects. For example, there may be one or a plurality of first objects. In addition, “and/or” in the specification and claims represents at least one of connected objects, and the character “/” generally indicates that the contextually associated objects have an “or” relationship.

It should be noted that technologies described in the embodiments of this application are not limited to a Long Term Evolution (LTE) or LTE-Advanced (LTE-A) system, and may also be applied to other wireless communication systems, for example, Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and other systems. The terms “system” and “network” in the embodiments of this application are often used interchangeably, and the technologies described herein may be used in the above-mentioned systems and radio technologies as well as other systems and radio technologies. In the following descriptions, a New Radio (NR) system is described for an illustration purpose, and NR terms are used in most of the following descriptions, but these technologies may also be applied to other applications than an NR system application, for example, the 6th Generation (6G) communication system.

FIG. 1 is a block diagram of a wireless communication system to which the embodiments of this application are applicable. The wireless communication system includes a terminal 11 and a network-side device 12. The terminal 11 may be a terminal-side device, for example, a mobile phone, a tablet personal computer, a laptop computer or called as a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, a vehicle user equipment (VUE), a pedestrian user equipment (PUE), a smart home device (wireless communication-enabled home devices such as refrigerators, televisions, washing machines, or furniture), a gaming console, a personal computer (PC), a teller machine, or a self-service machine. The wearable device includes a smart watch, a smart band, a smart earphone, smart glasses, smart jewelry (a smart bangle, a smart bracelet, a smart ring, a smart necklace, a smart ankle bangle, a smart anklet, and the like), a smart wristband, smart clothing, and the like. It should be noted that a specific type of the terminal 11 is not limited in the embodiments of this application. The network-side device 12 may include an access network device or a core network device, where the access network device may also be referred to as a radio access network device, Radio Access Network (RAN), radio access network function, or radio access network unit. The access network device may include a base station, a WLAN access point, a Wi-Fi node, and the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission Reception Point (TRP), or other appropriate terms in the art. Provided that the same technical effects are achieved, the base station is not limited to any specific technical term. It should be noted that in the embodiments of this application, only the base station in the NR system is used as an example for description, and the specific type of the base station is not limited.

The following describes in detail the monitoring method and apparatus, terminal, and readable storage medium provided in the embodiments of this application by using specific embodiments and application scenarios thereof with reference to the accompanying drawings.

Some concepts and/or terms used in the technical solutions of the embodiments of this application are explained below.

### (1) First Receiver

The first receiver in the embodiments of this application is configured to receive a wake-up signal. To be specific, the first receiver in the embodiments of this application may be referred to as a Low-Power Wake-Up receiver (LP WUR), or referred to as a low-power receiving module. A basic working principle of the LP WUR is that a receiving end includes a first module and a second module, where the first module is a main communication module configured to send and receive mobile communication data, and the second module is a low-power receiving module configured to receive a wake-up signal.

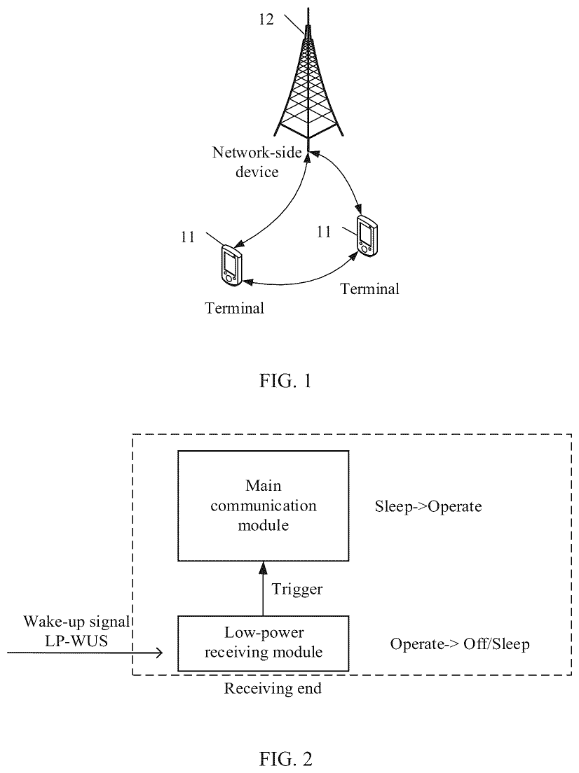

For example, as shown in FIG. 2, the terminal turns on the low-power receiving module to perform the wake-up signal (LP-WUS) monitoring and turns off the main communication module in a power saving state. Upon arrival of downlink data, a network sends a wake-up signal to the terminal; after having monitored the wake-up signal through the low-power receiving module, the terminal triggers the main communication module to switch from turning off to turning on after a series of determination; and at this moment, the low-power receiving module enters a turn-off state from a working state. Generally, the low-power receiving module can be turned on continuously or turned on intermittently, and can receive a low-power wake-up signal when turned on.

### (2) Wake-Up Signal

To reduce reception activities of the terminal in a standby state so that Radio Frequency (RF) and baseband modules are truly turned off to significantly reduce power consumption of communication reception, a receiver whose power is nearly “zero” (that is, the first receiver mentioned above, also referred to as a low-power wake-up receiver) is introduced into a receiving module of the terminal. This receiver whose power is nearly “zero” does not require complex signal detection (such as amplification, filtering, quantization, and the like) by the RF module and signal processing by the baseband module, but rather relies on passive matched filtering and low-power signal processing.

On a base station side, the receiver whose power is nearly “zero” can be activated to acquire an activation notification as long as a wake-up signal is triggered on demand (on-demand), thereby triggering a series of procedures in the terminal, for example, turning on an RF sending and receiving module and a baseband processing module. Generally, such type of wake-up signals are some simple on-off keying signals (on-off keying), so that the receiver can acquire a wake-up notification through processes such as simple power detection and subsequent possible sequence detection and identification.

In addition, while the terminal turns on the low-power wake-up receiver to receive the wake-up signal, a main receiver module can be maintained to work in a low power consumption level, thereby achieving power saving by receiving the wake-up signal.

In the monitoring method and apparatus, the terminal, and the readable storage medium provided in the embodiments of this application, the terminal acquires first indication information, where the first indication information is used for indicating whether the terminal performs wake-up signal monitoring; the terminal performs a first behavior in a case that the first indication information indicates that the terminal performs the wake-up signal monitoring, where the first behavior includes: wake-up signal monitoring and/or a second behavior. The second behavior includes at least one of the following: applying a first power saving mode; suspending sending of first content; suspending receiving or monitoring of second content; turning on a first receiver, where the first receiver is configured to receive the wake-up signal; or entering a first sleep state. In this way, the first indication information indicates whether the terminal performs the wake-up signal monitoring, so that the terminal can selectively perform wake-up signal monitoring according to indication of the first indication information and can also selectively perform other behaviors (such as the foregoing second behavior) during wake-up signal monitoring, thereby further saving power and improving communication power efficiency of a system.

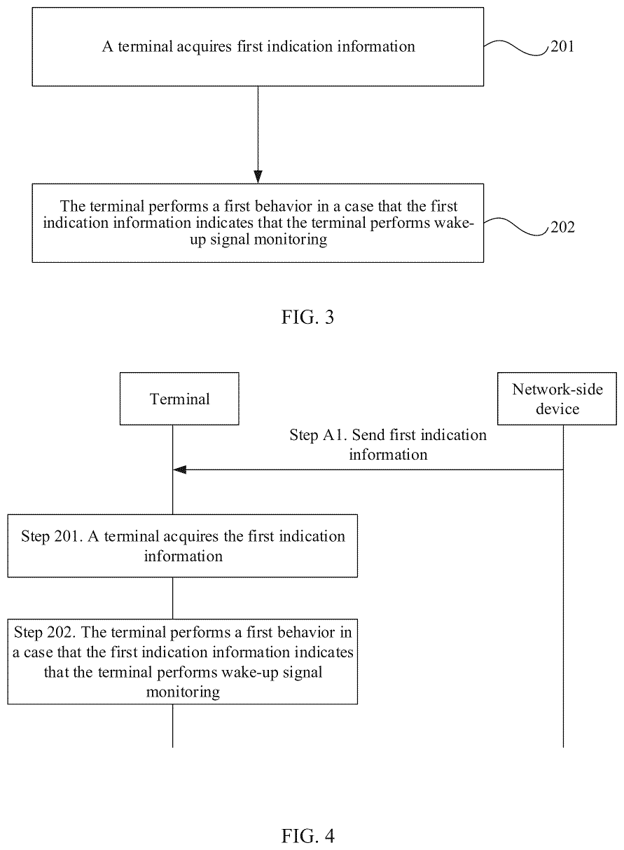

An embodiment of this application provides a monitoring method, and FIG. 3 is a flowchart of the monitoring method according to this embodiment of this application. As shown in FIG. 3, the monitoring method according to this embodiment of this application may include the following step 201 and step 202.

Step 201. The terminal acquires first indication information.

In this embodiment of this application, the first indication information is used for indicating whether the terminal performs wake-up signal monitoring.

Step 202. The terminal performs a first behavior in a case that the first indication information indicates that the terminal performs the wake-up signal monitoring.

In this embodiment of this application, the first behavior includes: wake-up signal monitoring and/or a second behavior.

In this embodiment of this application, the second behavior includes at least one of the following:
applying a first power saving mode;
suspending sending of first content;
suspending receiving or monitoring of second content;
turning on first receiver; or
entering a first sleep state.

In an embodiment, the first receiver is configured to receive the wake-up signal.

For example, the first receiver may be a low-power wake-up receiver.

For example, the first receiver differs from a main receiver for receiving an NR channel or NR signal.

It can be understood that a receiving end of the terminal includes a first receiver for receiving a wake-up signal and a main receiver for receiving an NR channel or signal.

In an embodiment, the terminal suspends transmission of a channel and/or signal in a sleep state.

In an embodiment, the first sleep mode may be at least one of one or more predetermined sleep modes. In other words, the first sleep mode may be a specified sleep mode.

In an embodiment, the sleep state includes at least one of the following:
Deep sleep;
Light sleep; or
Micro sleep.

In addition, it should be noted that different sleep states correspond to different switch delay. In different sleep states, operating states of a communication-related module of the terminal are also different.

In an embodiment, the first power saving mode is at least one power saving mode configured by a network or prescribed in a protocol. Different power saving modes are associated with different parameter configurations.

It should be noted that different parameter configurations represent at least one of different parameters and different parameter values.

In an embodiment, the power saving mode is related to at least one of the following parameter configurations:

a Bandwidth Part (BWP), a quantity of transmitting antennas or transmitting channels, a quantity of receiving antennas or receiving channels, a maximum quantity of downlink multiple-input multiple-output (MIMO) layers, a maximum quantity of uplink MIMO layers, a control resource set (CORESET), a search space group, a search space, uplink component carriers with same activation time, downlink component carriers with same activation time, a time interval between a physical downlink control channel (PDCCH) and a physical downlink shared channel (PDSCH) scheduled by the PDCCH, a time interval between the PDSCH and a hybrid automatic repeat request acknowledgement (Hybrid automatic repeat request acknowledgement, HARQ-ACK), a time interval between the PDCCH and a Physical Uplink Shared Channel (PUSCH) scheduled by the PDCCH, a PDSCH processing delay, a PUSCH preparation delay, a PDCCH monitoring period, a PDCCH monitoring offset, a PDCCH monitoring duration, a maximum uplink transmission rate, a maximum downlink transmission rate, a quantity of Channel State Information (CSI) reports processed by the terminal simultaneously, a quantity of beam management reports processed by the terminal simultaneously, a quantity of measurement resources received or processed by the terminal simultaneously, a delay related to the CSI reports, or a delay related to the beam management reports.

For example, the time interval between the PDCCH and the PDSCH may be a minimum scheduling offset, that is, a minimum time interval between the PDCCH and the PDSCH scheduled by the PDCCH. In addition, the time interval between the PDCCH and the PDSCH scheduled by the PDCCH is referred to as K0.

For example, the time interval between the PDCCH and the PUSCH scheduled by the PDCCH may be a minimum scheduling offset, that is, a minimum time interval between the PDCCH and the PUSCH scheduled by the PDCCH. In addition, the time interval between the PDCCH and the PUSCH scheduled by the PDCCH is referred to as K2.

In an embodiment, the network-side device can configure a default power saving mode for the terminal.

For example, each power saving mode may include one or more of the foregoing parameters.

For example, each power saving mode may correspond to one or more parameter values.

For example, different power saving modes are associated with different parameters, and/or different power saving modes are associated with different parameter values.

For example, in a first power saving mode, at least one of the foregoing parameter configurations adopts a specified parameter configuration.

For example, the following target parameter configurations are applied in the first power saving mode:
(a) a target search space group, for example, a default search space group, or a power saving search space group (which refers to a search space group with a relatively sparse PDCCH monitoring period); and
(b) a target BWP, for example, a default BWP or an initial BWP.

In an embodiment, the first content includes at least one of the following: a Scheduling Request (SR), a Buffer Status Report (BSR), a Configured Grant (CG), a HARQ-ACK, a Physical Random Access Channel (PRACH), a message A (Msg.A), a message 3 (Msg.3), a CSI report, or a Sounding Reference Signal (SRS).

In an embodiment, the second content includes at least one of the following: a first Synchronization Signal and PBCH block (SSB), a first CSI Reference Signal (CSI-RS), a Semi-Persistent Scheduling PDSCH (SPS PDSCH), or a first PDCCH.

In an embodiment, the first PDCCH includes at least one of the following: a PDCCH of a UE-specific search space (USS), a PDCCH of a Type-3 Common Search Space (CSS), or a PDCCH of a non-Type-3 CSS.

In an embodiment, the first SSB is a specific-functionality SSB.

For example, the first SSB may be an SSB used for mobility measurement (an SSB for serving cell measurement, or an SSB for neighboring cell measurement), an SSB for Automatic Gain Control (AGC), an SSB for Radio Link Monitoring (RLM), an SSB for Beam Failure Recovery (BFR), or the like.

In an embodiment, the first CSI-RS is a specific-functionality or specific type of CSI-RS.

For example, the specific-functionality CSI-RS includes at least one of the following: a CSI-RS for L1 reference signal received power (L1-RSRP), a CSI-RS for channel quality indicator (CQI), a CSI-RS for rank indicator (RI), a CSI-RS for precoding matrix indicator (PMI), or a CSI-RS for interference measurement.

For example, the specific type of CSI-RS includes at least one of the following: a Non-Zero Power CSI-RS (NZP CSI-RS) or a Zero Power CSI-RS (ZP CSI-RS).

For example, the specific-period type of CSI-RS may be a periodic CSI-RS or a semi-static CSI-RS.

In an embodiment of this application, as shown in FIG. 4, before the foregoing step 201, the monitoring method provided by this embodiment of this application may further include the following step A1.

Step A1: The network-side device sends the first indication information to the terminal.

Correspondingly, the terminal receives the first indication information sent by the network-side device.

In this embodiment of this application, the first indication information may be carried by target signaling.

For example, in this embodiment of this application, the target signaling includes at least one of the following:
Downlink Control Information (DCI); and
a Medium Access Control Control Element (MAC CE); or
Radio Resource Control (RRC).

For example, the first indication information may implement indication through a PDCCH monitoring adaptation indication field (PDCCH monitoring adaptation indication field) in a DCI. For example, the first indication information can be combined with PDCCH skipping indication to indicate whether to perform the wake-up signal monitoring. For another example, the PDCCH monitoring adaptation indication can also indicate the first indication information with the indication of PDCCH skipping, (for example, indicating that the terminal performs the wake-up signal monitoring). In some embodiments, the DCI is DCI for scheduling data or DCI that is not for scheduling data.

In this way, by using signaling, the network-side device indicates a time at which the terminal enters wake-up signal monitoring instead of monitoring of other channels such as PDCCH or signals, thereby saving power.

In this embodiment of this application, the first indication information is configured by the network-side device.

In this embodiment of this application, in a case that the first indication information indicates that the terminal performs the wake-up signal monitoring, the terminal performs a first behavior. The first behavior includes a second behavior, and the second behavior may include turning on a low-power wake-up receiver and making the terminal receive the wake-up signal on the low-power wake-up receiver.

In this embodiment of this application, in the case that the first indication information indicates that the terminal performs the wake-up signal monitoring, the terminal performs the first behavior, where the first behavior includes the second behavior. In a case that the second behavior includes turning on the low-power wake-up receiver, turning on the first receiver includes any one of the following:
at an ending time of a time unit that has received the first indication information, turning on the first receiver;
at a starting time of a time unit following the time unit that has received the first indication information, turning on the first receiver; or
at an ending time of a second time interval starting from the ending time of the time unit that has received the first indication information, turning on the first receiver.

For example, the second time interval may be prescribed in a protocol or configured by the network-side device, and the second time interval is related to terminal capability.

In this embodiment of this application, the first indication information is used for indicating which sleep state the terminal enters.

In this embodiment of this application, the first indication information is further used for indicating that the terminal performs a fifth behavior, where the fifth behavior is related to channel and/or signal monitoring.

For example, indication content of the fifth behavior is related to whether the wake-up signal is monitored indicated by the first indication information. For example, if the first indication information indicates that the wake-up signal is to be monitored, the fifth behavior is equivalent to the second behavior; and if the first indication information indicates that the wake-up signal is not to be monitored, the fifth behavior is equivalent to the fourth behavior. To be specific, the fifth behavior includes the second behavior or the fourth behavior.

In this embodiment of this application, the first indication information is used for indicating whether the terminal uses a specific power saving mode. For example, the first indication information is further used for indicating that the terminal switches to a target search space group or a target BWP.

In this embodiment of this application, a validation time or application time of the first indication information is any one of the following:
the ending time of the time unit that has received the first indication information;
the starting time of the time unit following the time unit that has received the first indication information; or
the ending time of the first time interval starting from the ending time of the time unit that has received the first indication information.

It should be noted that the first time interval is the application or validation time of the first indication information.

For example, the first time interval is prescribed in a protocol or configured by the network, for example, being 3 ms. In addition, the first time interval is related to a turn-on/power-up delay of the low-power wake-up receiver.

For example, the terminal turns on the first receiver within the first time interval of the first indication information, that is, within the application time. In an example, the first time interval is related to at least one of the following: the terminal capability or the application time of the first indication information.

In this embodiment of this application, the first indication information is used for indicating whether the terminal performs the wake-up signal monitoring during a first time period.

In an embodiment, the first time period is at least one of the following:
a time period indicated by the first indication information;
a non-running time period of a Discontinuous Reception (DRX) timer;
a DRX duration period;
a PDCCH skipping duration; or
an application time period of a first search space group.

For example, the first search space group is a search space group that is not associated with any search space.

For example, the first indication information can indicate whether the terminal performs the wake-up signal (LP-WUS) monitoring during PDCCH skipping duration. For example, the first indication information indicates that the terminal needs to perform the wake-up signal (LP-WUS) monitoring during PDCCH skipping duration.

In this embodiment of this application, in a case that the first indication information is used for indicating whether the terminal performs the wake-up signal monitoring during the first time period, step 202 “The terminal performs a first behavior in a case that the first indication information indicates that the terminal performs the wake-up signal monitoring” may include step 202a.

Step 202a. The terminal performs the first behavior during the first time period in a case that the first indication information indicates that the terminal performs the wake-up signal monitoring during the first time period.

In the monitoring method provided in this embodiment of this application, the terminal acquires the first indication information. The first indication information is used for indicating whether the terminal performs the wake-up signal monitoring; the terminal performs the first behavior in a case that the first indication information indicates that the terminal performs the wake-up signal monitoring, where the first behavior includes: wake-up signal monitoring and/or the second behavior. The second behavior includes at least one of the following: applying a first power saving mode; suspending sending of first content; suspending receiving or monitoring of second content; turning on a first receiver, where the first receiver is configured to receive the wake-up signal; or entering a first sleep state. In this way, the first indication information indicates whether the terminal performs the wake-up signal monitoring, so that the terminal can selectively perform wake-up signal monitoring according to indication of the first indication information and can also selectively perform other behaviors (such as the foregoing second behavior) during wake-up signal monitoring, thereby further saving power and improving communication power efficiency of a system.

In this embodiment of this application, after step 201, the monitoring method provided in this embodiment of this application further includes step 301.

Step 301. The terminal performs a third behavior in a case that the first indication information indicates that the terminal does not perform the wake-up signal monitoring.

In this embodiment of this application, the third behavior includes: not performing the wake-up signal monitoring, and/or a fourth behavior. In some embodiments, the fourth behavior is related to channel and/or signal monitoring.

In this embodiment of this application, after step 201, the monitoring method provided in this embodiment of this application further includes step 302.

Step 302. The terminal performs a sixth behavior in a case that the terminal performs the wake-up signal monitoring.

In this embodiment of this application, the sixth behavior includes at least one of the following:
switching to a second power saving mode;
resuming or starting the sending of the first content; or
resuming or starting the receiving or monitoring of the second content.

It should be noted that for the first content and the second content, reference may be made to the above description. Details are not described herein again.

In this embodiment of this application, the second power saving mode is one of at least one power saving mode configured by a network side or prescribed in a protocol, where different power saving modes are associated with different parameter configurations.

In an embodiment, the power saving mode is related to at least one of the following parameter configurations:

a BWP, a quantity of transmitting antennas or transmitting channels, a quantity of receiving antennas or receiving channels, a maximum quantity of downlink MIMO layers, a maximum quantity of uplink MIMO layers, a CORESET, a search space group, a search space, uplink component carriers with same activation time, downlink component carriers with same activation time, a time interval between a PDCCH and a PDSCH scheduled by the PDCCH, a time interval between the PDSCH and a HARQ-ACK, a time interval between the PDCCH and a PUSCH scheduled by the PDCCH, a PDSCH processing delay, a PUSCH preparation delay, a PDCCH monitoring period, a PDCCH monitoring offset, a PDCCH monitoring duration, a maximum uplink transmission rate, a maximum downlink transmission rate, a quantity of CSI reports processed by the terminal simultaneously, a quantity of beam management reports processed by the terminal simultaneously, a quantity of measurement resources received or processed by the terminal simultaneously, a delay related to the CSI reports, or a delay related to the beam management reports.

It should be noted that for description of the second power saving mode, reference may be made to the above description of the first power saving mode. Details are not described herein again.

Further in this embodiment of this application, the foregoing step 302 “The terminal performs a sixth behavior” may include the following step 302a.

Step 302a. The terminal performs the corresponding sixth behavior based on a type of the monitored wake-up signal.

In this embodiment of this application, after the wake-up signal monitoring, the terminal can perform different sixth behaviors based on different types of the wake-up signals monitored.

For example, the network-side device can configure a first association relationship between the type of the wake-up signal and the sixth behavior for the terminal, and different types of the wake-up signals may correspond to the same or different sixth behaviors.

In this embodiment of this application, in addition to indicating whether the wake-up signal is to be monitored, the first indication information is further used for indicating a type of the wake-up signal monitored by the terminal. For example, the first indication information indicates whether the terminal monitors a first type of wake-up signal.

In this embodiment of this application, in a case that the first indication information is used for indicating the type of the monitored wake-up signal, the terminal can monitor a specific type of wake-up signal according to the indication of the first indication information, thereby performing the second behavior corresponding to the specific type of wake-up signal, based on the first indication.

For example, the network-side device can configure a second association relationship between the type of the wake-up signal and the second behavior for the terminal, and different types of the wake-up signals correspond to the same or different second behaviors.

For example, the first indication information is used for indicating that the terminal performs the wake-up signal (WUS) monitoring, and the first indication information is further used for indicating the second behavior (for example, during the wake-up signal WUS monitoring, the terminal skips PDCCH monitoring, and/or the terminal switches to a target search space group (a power saving search space group)).

For example, while the terminal is performing the wake-up signal WUS monitoring, the second behavior is configured by the network-side device or prescribed in a protocol (for example, the terminal does not perform at least one of transmission of a PDSCH or PUSCH configured by a higher layer or sending of SR configured by the higher layer). In addition, after the wake-up signal monitoring, the terminal resumes at least one of the transmission of the PDSCH or PUSCH or the sending of the SR.

For example, after the terminal performs the wake-up signal WUS monitoring, the terminal performs the sixth behavior (for example, switching to the first search space group and/or switching to a target BWP).

In this embodiment of this application, the process of “the terminal performs wake-up signal monitoring” in the foregoing step 202 includes the following step 202b.

Step 202b. The terminal performs wake-up signal monitoring on a first type of time unit.

For example, the first type of time unit includes at least one of the following: a downlink time unit, a semi-static downlink time unit, a flexible time unit, a special time unit, an uplink time unit, or a semi-static uplink time unit.

For example, the terminal receives the wake-up signal through the first receiver, and the first receiver can operate simultaneously with the main receiver, so the terminal can receive the wake-up signal (WUS) on any type of time unit (without considering slot format: D S U slot/symbol).

In this embodiment of this application, the monitoring method provided in this embodiment of this application may further include the following step 303.

Step 303. The terminal does not expect to receive a first PDCCH after receiving the first indication information and before turning on the first receiver.

For example, the first PDCCH includes a PDCCH for scheduling a PDSCH or a PDCCH of a PUSCH.

For example, the network triggers wake-up signal monitoring only when the main receiver enters a specific state.

For example, if the network-side device configures that the wake-up signal is monitored during PDCCH skipping duration, the terminal needs to perform the wake-up signal (LP-WUS) monitoring during PDCCH skipping duration. If the network-side device does not configure or configure that the wake-up signal is not monitored during PDCCH skipping duration, the terminal in a connected state does not need to perform the wake-up signal (LP-WUS) monitoring during PDCCH skipping duration.

For example, in a case that the terminal performs the wake-up signal monitoring, PDCCH monitoring is resumed.

In this way, by sending a target instruction, the terminal dynamically indicates whether to monitor the wake-up signal during PDCCH skipping duration, thereby avoiding some data transmission delays caused by no wake-up signal monitoring statically configured by a network side, or avoiding increased power consumption caused by unnecessary PDCCH monitoring resuming due to false detection of the wake-up signal.

In this embodiment of this application, in a case that the network-side device indicates that the terminal switches to the power saving mode while performing the wake-up signal monitoring, the terminal can use or turn on the low-power receiving module to receive the wake-up signal. The terminal receives the wake-up signal on the first receiver that differs from the main receiver, or a frequency range for receiving the wake-up signal differs from a frequency range in which a current main receiver receives and sends signals. Therefore, it is unnecessary to limit the terminal to monitor the wake-up signal only in a downlink slot.

The monitoring method provided in this embodiment of this application may be executed by a monitoring apparatus. In an embodiment of this application, the monitoring method being executed by the monitoring apparatus is used as an example for describing the apparatus for the monitoring method provided in the embodiments of this application.

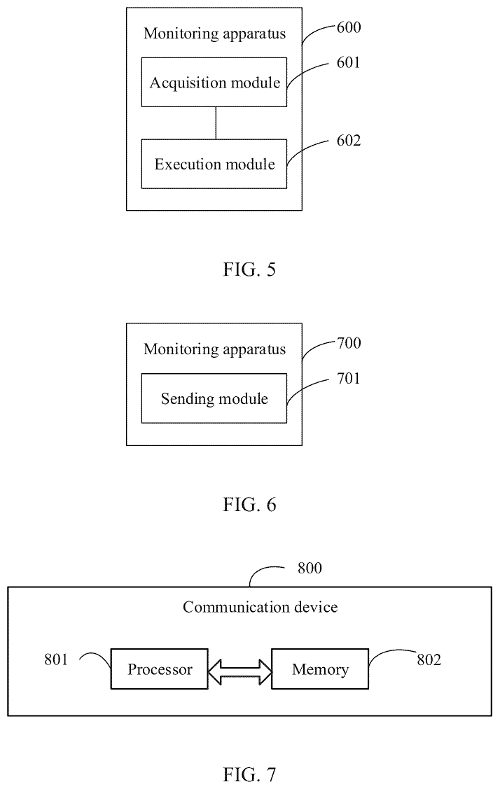

This embodiment of this application provides a monitoring apparatus. As shown in FIG. 5, the monitoring apparatus 600 includes: an acquisition module 601 and an execution module 602. The acquisition module 601 is configured to acquire first indication information, where the first indication information is used for indicating whether a terminal performs wake-up signal monitoring. The execution module 602 is configured to perform a first behavior in a case that the first indication information indicates that the terminal performs the wake-up signal monitoring, where the first behavior includes: wake-up signal monitoring and/or a second behavior. The second behavior includes at least one of the following: applying a first power saving mode; suspending sending of first content; suspending receiving or monitoring of second content; turning on a first receiver, where the first receiver is configured to receive the wake-up signal; or entering a first sleep state, where the terminal suspends transmission of a channel and/or signal in the sleep state.

In this embodiment of this application, the execution module 602 is further configured to perform a third behavior when the first indication information indicates that the terminal does not perform the wake-up signal monitoring. The third behavior includes: not performing the wake-up signal monitoring, and/or a fourth behavior, where the fourth behavior is related to channel and/or signal monitoring.

In this embodiment of this application, the first indication information is further used for indicating that the terminal performs a fifth behavior, where the fifth behavior is related to channel and/or signal monitoring.

In this embodiment of this application, the first power saving mode is one of at least one power saving mode configured by a network or prescribed in a protocol, where different power saving modes are associated with different parameter configurations.

In this embodiment of this application, the execution module 602 is further configured to perform a sixth behavior when the terminal performs the wake-up signal monitoring, where the sixth behavior includes at least one of the following: switching to a second power saving mode; resuming or starting the sending of the first content; or resuming or starting the receiving or monitoring of the second content.

In this embodiment of this application, the second power saving mode is one of at least one power saving mode configured by a network side or prescribed in a protocol, where different power saving modes are associated with different parameter configurations.

In this embodiment of this application, the power saving mode is related to at least one of the following parameters: a BWP, a quantity of transmitting antennas or transmitting channels, a quantity of receiving antennas or receiving channels, a maximum quantity of downlink MIMO layers, a maximum quantity of uplink MIMO layers, a CORESET, a search space group, a search space, uplink component carriers with same activation time, downlink component carriers with same activation time, a time interval between a PDCCH and a PDSCH scheduled by the PDCCH, a time interval between the PDSCH and a HARQ-ACK, a time interval between the PDCCH and a PUSCH scheduled by the PDCCH, a PDSCH processing delay, a PUSCH preparation delay, a PDCCH monitoring period, a PDCCH monitoring offset, a PDCCH monitoring duration, a maximum uplink transmission rate, a maximum downlink transmission rate, a quantity of CSI reports processed by the terminal simultaneously, a quantity of beam management reports processed by the terminal simultaneously, a quantity of measurement resources received or processed by the terminal simultaneously, a delay related to the CSI reports, or a delay related to the beam management reports.

In this embodiment of this application, the execution module 602 is configured to perform the corresponding sixth behavior based on a type of the monitored wake-up signal.

In this embodiment of this application, the first indication information is further used for indicating the type of the wake-up signal monitored by the terminal.

In this embodiment of this application, the first indication information indicates whether the terminal performs the wake-up signal monitoring during a first time period, and the execution module 602 is configured to perform the first behavior during the first time period in a case that the first indication information indicates that the terminal performs the wake-up signal monitoring during the first time period.

In this embodiment of this application, the first time period is at least one of the following: a time period indicated by the first indication information; a non-running time period of a DRX timer; a DRX duration period; a PDCCH skipping duration; or an application time period of a first search space group; where the first search space group is a search space group that is not associated with any search space.

In this embodiment of this application, a validation time or application time of the first indication information is any one of the following: an ending time of a time unit that has received the first indication information; a starting time of a time unit following the time unit that has received the first indication information; or an ending time of a first time interval starting from the ending time of the time unit that has received the first indication information; where the first time interval is prescribed in a protocol or configured by a network-side device.

In this embodiment of this application, the first indication information is carried by target signaling, where the target signaling includes at least one of the following: DCI, MAC CE, or RRC.

In this embodiment of this application, the first indication information is configured by the network-side device.

In this embodiment of this application, the execution module 602 is configured to perform wake-up signal monitoring on the first type of time unit, where the first type of time unit includes at least one of the following: a downlink time unit, a semi-static downlink time unit, a flexible time unit, a special time unit, an uplink time unit, or a semi-static uplink time unit.

In this embodiment of this application, the turning on the first receiver includes any one of the following: turning on the first receiver after receiving the ending time of the time unit that has received the first indication information; turning on the first receiver after receiving the starting time of the time unit following the time unit that has received the first indication information; or turning on the first receiver after receiving the ending time of the second time interval starting from the ending time of the time unit that has received the first indication information; where the second time interval is prescribed in a protocol or configured by the network-side device.

In this embodiment of this application, the execution module 602 is further configured to not expect to receive a first PDCCH after receiving the first indication information and before turning on the first receiver.

In this embodiment of this application, the first content includes at least one of the following: an SR, a BSR, a configured grant CG, a HARQ-ACK, a PRACH, a Msg.A, a Msg.3, a CSI report, or an SRS.

In this embodiment of this application, the second content includes at least one of the following: a first SSB, a first CSI-RS, an SPS PDSCH, or a first PDCCH.

In this embodiment of this application, the first PDCCH includes at least one of the following: a PDCCH of a USS, a PDCCH of a Type-3 CSS, or a PDCCH of a non-Type-3 CSS.

In this embodiment of this application, the first SSB is a specific-functionality SSB; and/or the first CSI-RS is a specific-functionality CSI-RS or a specific-period type of CSI-RS.

In the monitoring apparatus provided in this embodiment of this application, the apparatus acquires the first indication information, where the first indication information is used for indicating whether the terminal performs the wake-up signal monitoring; the terminal performs the first behavior in a case that the first indication information indicates that the terminal performs the wake-up signal monitoring, where the first behavior includes: wake-up signal monitoring and/or the second behavior, and the second behavior includes at least one of the following: applying the first power saving mode; suspending sending of the first content; suspending receiving or monitoring of the second content; turning on the first receiver, where the first receiver is configured to receive the wake-up signal; and entering the first sleep state. In this way, the first indication information indicates whether the terminal performs the wake-up signal monitoring, so that the terminal can selectively perform wake-up signal monitoring according to indication of the first indication information and can also selectively perform other behaviors (such as the foregoing second behavior) during wake-up signal monitoring, thereby further saving power and improving communication power efficiency of a system.

An embodiment of this application provides a monitoring apparatus. As shown in FIG. 6, the monitoring apparatus 700 includes: a sending module 701.

The sending module 701 is configured to send first indication information, where the first indication information is used for indicating whether a terminal performs wake-up signal monitoring.

In this embodiment of this application, the first indication information is further used for indicating that the terminal performs a fifth behavior, where the fifth behavior is related to channel and/or signal monitoring.

In this embodiment of this application, the first indication information is further used for indicating a type of the wake-up signal monitored by the terminal.

In this embodiment of this application, the first indication information is used for indicating whether the terminal performs the wake-up signal monitoring during a first time period.

The first time period is at least one of the following:
a time period indicated by the first indication information;
a non-running time period of a DRX timer;
a DRX duration period;
a PDCCH skipping duration; and
an application time period of a first search space group; where
the first search space group is a search space group that is not associated with any search space.

In this embodiment of this application, a validation time or application time of the first indication information is any one of the following:
an ending time of a time unit that has received the first indication information;
a starting time of a time unit following the time unit that has received the first indication information; and
an ending time of a first time interval starting from the ending time of the time unit that has received the first indication information, where
the first time interval is prescribed in a protocol or configured by a network-side device.

In this embodiment of this application, the first indication information is carried by target signaling, where the target signaling includes at least one of the following: DCI, MAC CE, and RRC.

In this way, in the monitoring apparatus provided in this embodiment of this application, the network-side device indicates whether the terminal performs the wake-up signal monitoring by sending the first indication information for the terminal, so that the terminal can selectively perform wake-up signal monitoring according to indication of the first indication information and can also selectively perform other behaviors (such as the foregoing second behavior) during wake-up signal monitoring, thereby further saving power and improving communication power efficiency of a system.

The monitoring apparatus in this embodiment of this application may be an electronic device such as an electronic device with an operating system, or a component in an electronic device such as an integrated circuit or chip. The electronic device may be a terminal or another device than a terminal. For example, the terminal may include but is not limited to the types of the terminal 11 listed above, and the another device may be a server, a Network Attached Storage (NAS), or the like. This is not limited in this embodiment of this application.

The monitoring apparatus provided in this embodiment of this application can implement the processes implemented in the foregoing method embodiment, with the same technical effects achieved. To avoid repetition, details are not described herein again.

As shown in FIG. 7, an embodiment of this application further provides a communication device 800 including a processor 801 and a memory 802. The memory 802 stores a program or instructions capable of running on the processor 801. For example, when the communication device 800 is a terminal, when the program or instructions are executed by the processor 801, the steps of the foregoing monitoring method embodiment are implemented, with the same technical effects achieved. To avoid repetition, details are not described herein again. When the communication device 800 is a network-side device, when the program or instructions are executed by the processor 801, the steps of the foregoing monitoring method embodiment are implemented, with the same technical effects achieved. To avoid repetition, details are not described herein again.

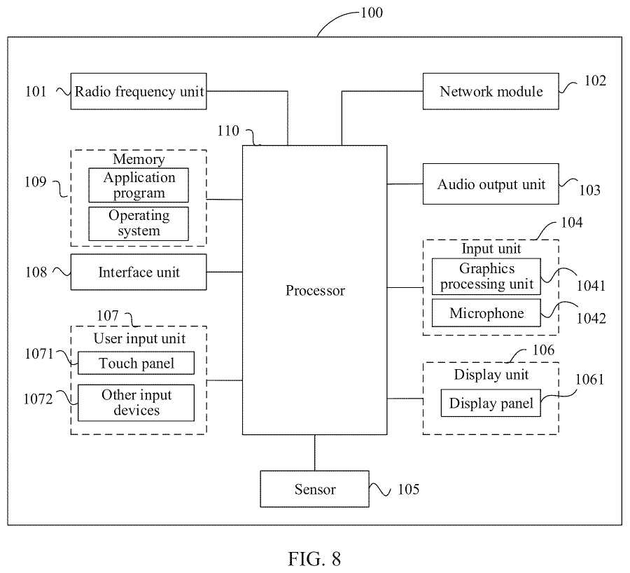

An embodiment of this application further provides a terminal including a processor and a communication interface, where the processor is configured to acquire first indication information, and the first indication information is used for indicating whether the terminal performs wake-up signal monitoring. The processor is further configured to perform a first behavior in a case that the first indication information indicates that the terminal performs the wake-up signal monitoring, where the first behavior includes: wake-up signal monitoring and/or a second behavior. The second behavior includes at least one of the following: applying a first power saving mode; suspending sending of first content; suspending receiving or monitoring of second content; turning on a first receiver, where the first receiver is configured to receive the wake-up signal; and entering a first sleep state, where the terminal suspends transmission of a channel and/or signal in the sleep state. This terminal embodiment corresponds to the foregoing method embodiment on the terminal side. The implementation processes and implementation manners of the foregoing method embodiments are all applicable to this terminal embodiment, with the same technical effects achieved. FIG. 8 is a schematic diagram of a hardware structure of a terminal implementing thus embodiment of this application.

The terminal 100 includes but is not limited to at least part of these components: a radio frequency unit 101, a network module 102, an audio output unit 103, an input unit 104, a sensor 105, a display unit 106, a user input unit 107, an interface unit 108, a memory 109, a processor 110, and the like.

Persons skilled in the art can understand that the terminal 100 may further include a power supply (such as a battery) for supplying power to the components. The power supply can be logically connected to the processor 110 through a power management system. In this way, functions such as charge management, discharge management, and power consumption management are implemented by using the power management system. The structure of the terminal shown in FIG. 8 does not constitute any limitation on the terminal. The terminal may include more or fewer components than shown in the figure, or a combination of some components, or the components arranged differently. Details are not described herein again.

It can be understood that in this embodiment of this application, the input unit 104 may include a Graphics Processing Unit (GPU) 1041 and a microphone 1042. The graphics processing unit 1041 processes image data of a static picture or video obtained by an image capture apparatus (such as a camera) in a video capture mode or an image capture mode. The display unit 106 may include a display panel 1061, and the display panel 1061 may be configured in a form of a liquid crystal display, an organic light-emitting diode, or the like. The user input unit 107 includes at least one of a touch panel 1071 and other input devices 1072. The touch panel 1071 is also referred to as a touchscreen. The touch panel 1071 may include two parts: a touch detection apparatus and a touch controller. The other input devices 1072 may include but are not limited to a physical keyboard, a function button (such as a volume control button or an on/off button), a trackball, a mouse, and a joystick. Details are not described herein again.

In this embodiment of this application, the radio frequency unit 101 receives downlink data from a network-side device and sends the data to the processor 110 for processing; and the radio frequency unit 101 can additionally send uplink data to the network-side device. Generally, the radio frequency unit 101 includes but is not limited to an antenna, an amplifier, a transceiver, a coupler, a low noise amplifier, a duplexer, and the like.

The memory 109 may be configured to store a software program or instructions and various data. The memory 109 may mainly include a first storage area for storing a program or instructions and a second storage area for storing data. The first storage area may store an operating system, an application program or instructions required by at least one function (for example, a sound playback function or an image playback function), and the like. In addition, the memory 109 may be a volatile memory or a non-volatile memory, or the memory 109 may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 109 in this embodiment of this application includes but is not limited to these or any other applicable types of memories.

The processor 110 may include one or more processing units. In some embodiments, the processor 110 may integrate an application processor and a modem processor. The application processor primarily processes operations involving an operating system, a user interface, an application program, and the like. The modem processor primarily processes radio communication signals, for example, being a baseband processor. It can be understood that the modem processor may be not integrated in the processor 110.

In this embodiment of this application, the processor 110 is further configured to perform a third behavior in a case that the first indication information indicates that the terminal does not perform the wake-up signal monitoring, where the third behavior includes: not performing the wake-up signal monitoring, and/or a fourth behavior. The fourth behavior is related to channel and/or signal monitoring.

In this embodiment of this application, the first indication information is further used for indicating that the terminal performs a fifth behavior, where the fifth behavior is related to channel and/or signal monitoring.

In this embodiment of this application, the first power saving mode is one of at least one power saving mode configured by a network or prescribed in a protocol, where different power saving modes are associated with different parameter configurations.

In this embodiment of this application, the processor 110 is further configured to perform a sixth behavior in a case that the terminal performs the wake-up signal monitoring, where the sixth behavior includes at least one of the following: switching to a second power saving mode; resuming or starting the sending of the first content; and resuming or starting the receiving or monitoring of the second content.

In this embodiment of this application, the second power saving mode is one of at least one power saving mode configured by a network side or prescribed in a protocol, where different power saving modes are associated with different parameter configurations.

In this embodiment of this application, the power saving mode is related to at least one of the following parameters: a BWP, a quantity of transmitting antennas or transmitting channels, a quantity of receiving antennas or receiving channels, a maximum quantity of downlink MIMO layers, a maximum quantity of uplink MIMO layers, a CORESET, a search space group, a search space, uplink component carriers with same activation time, downlink component carriers with same activation time, a time interval between a PDCCH and a PDSCH scheduled by the PDCCH, a time interval between the PDSCH and a HARQ-ACK, a time interval between the PDCCH and a PUSCH scheduled by the PDCCH, a PDSCH processing delay, a PUSCH preparation delay, a PDCCH monitoring period, a PDCCH monitoring offset, a PDCCH monitoring duration, a maximum uplink transmission rate, a maximum downlink transmission rate, a quantity of CSI reports processed by the terminal simultaneously, a quantity of beam management reports processed by the terminal simultaneously, a quantity of measurement resources received or processed by the terminal simultaneously, a delay related to the CSI reports, and a delay related to the beam management reports.

In this embodiment of this application, the execution module 602 is configured to perform the corresponding sixth behavior based on a type of the monitored wake-up signal.

In this embodiment of this application, the first indication information is further used for indicating the type of the wake-up signal monitored by the terminal.

In this embodiment of this application, the first indication information indicates whether the terminal performs the wake-up signal monitoring in a first time period, and the processor 110 is configured to perform the first behavior during the first time period in a case that the first indication information indicates that the terminal performs the wake-up signal monitoring during the first time period.

In this embodiment of this application, the first time period is at least one of the following: a time period indicated by the first indication information; a non-running time period of a DRX timer; a DRX duration period; a PDCCH skipping duration; and an application time period of a first search space group; where the first search space group is a search space group that is not associated with any search space.

In this embodiment of this application, a validation time or application time of the first indication information is any one of the following: an ending time of a time unit that has received the first indication information; a starting time of a time unit following the time unit that has received the first indication information; and an ending time of a first time interval starting from the ending time of the time unit that has received the first indication information; where the first time interval is prescribed in a protocol or configured by a network-side device.

In this embodiment of this application, the first indication information is carried by target signaling, where the target signaling includes at least one of the following: DCI, MAC CE, and RRC.

In this embodiment of this application, the first indication information is configured by the network-side device.

In this embodiment of this application, the processor 110 is configured to perform wake-up signal monitoring on a first type of time unit, where the first type of time unit includes at least one of the following: a downlink time unit, a semi-static downlink time unit, a flexible time unit, a special time unit, an uplink time unit, and a semi-static uplink time unit.

In this embodiment of this application, the turning on the first receiver includes any one of the following: turning on the first receiver after receiving the ending time of the time unit that has received the first indication information; turning on the first receiver after receiving the starting time of the time unit following the time unit that has received the first indication information; and turning on the first receiver after receiving the ending time of the second time interval starting from the ending time of the time unit that has received the first indication information; where the second time interval is prescribed in a protocol or configured by the network-side device.

In this embodiment of this application, the processor 110 is further configured to not expect to receive a first PDCCH after receiving the first indication information and before turning on the first receiver.

In this embodiment of this application, the first content includes at least one of the following: an SR, a BSR, a CG, a HARQ-ACK, a PRACH, a Msg.A, a Msg.3, a CSI report, and an SRS.

In this embodiment of this application, the second content includes at least one of the following: a first SSB, a first CSI-RS, an SPS PDSCH, and a first PDCCH.

In this embodiment of this application, the first PDCCH includes at least one of the following: a PDCCH of a USS, a PDCCH of a Type-3 CSS, and a PDCCH of a non-Type-3 CSS.

In this embodiment of this application, the first SSB is a specific-functionality SSB; and/or the first CSI-RS is a specific-functionality CSI-RS or a specific-period type of CSI-RS.

In the terminal provided in this embodiment of this application, the terminal acquires the first indication information, where the first indication information is used for indicating whether the terminal performs the wake-up signal monitoring; the terminal performs the first behavior in a case that the first indication information indicates that the terminal performs the wake-up signal monitoring, where the first behavior includes: wake-up signal monitoring and/or the second behavior, and the second behavior includes at least one of the following: applying the first power saving mode; suspending sending of the first content; suspending receiving or monitoring of the second content; turning on the first receiver, where the first receiver is configured to receive the wake-up signal; and entering the first sleep state. In this way, the first indication information indicates whether the terminal performs the wake-up signal monitoring, so that the terminal can selectively perform wake-up signal monitoring according to indication of the first indication information and can also selectively perform other behaviors (such as the foregoing second behavior) during wake-up signal monitoring, thereby further saving power and improving communication power efficiency of a system.

An embodiment of this application further provides a network-side device including a processor and a communication interface, where the processor is configured to send first indication information, and the first indication information is used for indicating whether a terminal performs wake-up signal monitoring. This network-side device embodiment corresponds to the foregoing network-side device method embodiment. The implementation processes and implementation manners of the foregoing method embodiments are all applicable to this network-side device embodiment, with the same technical effects achieved.

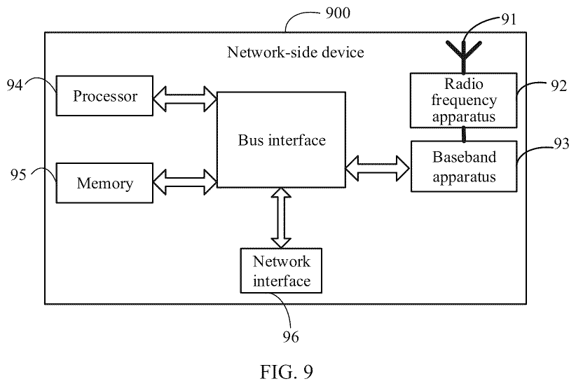

An embodiment of this application further provides a network-side device. As shown in FIG. 9, the network-side device 900 includes an antenna 91, a radio frequency apparatus 92, a baseband apparatus 93, a processor 94, and memory 95. The antenna 91 is connected to the radio frequency apparatus 92. In an uplink direction, the radio frequency apparatus 92 receives information by using the antenna 91, and sends the received information to the baseband apparatus 93 for processing. In a downlink direction, the baseband apparatus 93 processes to-be-sent information, and sends the information to the radio frequency apparatus 92; and the radio frequency apparatus 92 processes the received information and then sends the information out by using the antenna 91.

The method executed by the network-side device in the foregoing embodiment may be implemented on the baseband apparatus 93. The baseband apparatus 93 includes a baseband processor.

The baseband apparatus 93 may include, for example, at least one baseband processing unit, where a plurality of chips are disposed on the baseband processing unit. As shown in FIG. 9, one of the chips is, for example, a baseband processor, and is connected to the memory 95 through a bus interface to invoke the program in the memory 95, so as to perform the operations of the network device shown in the foregoing method embodiment.

The network-side device may further include a network interface 96, where the interface is, for example, a common public radio interface (CPRI).

The network-side device 900 in this embodiment of this application further includes: instructions or a program stored in the memory 95 and capable of running on the processor 94. The processor 94 invokes the instructions or program in the memory 95 to execute the method executed by the modules shown in FIG. 6, with the same technical effects achieved. To avoid repetition, details are not described herein again.

An embodiment of this application further provides a readable storage medium. The readable storage medium stores a program or instructions. When the program or instructions are executed by a processor, each process of the foregoing monitoring method embodiment is implemented, with the same technical effects achieved. To avoid repetition, details are not described herein again.

The processor is a processor in the terminal described in the foregoing embodiment. The readable storage medium includes a computer-readable storage medium such as a computer read-only memory ROM, a random access memory RAM, a magnetic disk, or an optical disc.

An embodiment of this application further provides a chip. The chip includes a processor and a communication interface. The communication interface is coupled to the processor. The processor is configured to run a program or instructions to implement each process of the foregoing monitoring method embodiment, with the same technical effects achieved. To avoid repetition, details are not described herein again.

It should be understood that the chip mentioned in this embodiment of this application may also be referred to as a system-level-chip, a system chip, a chip system, or a system-on-chip, or the like.

An embodiment of this application further provides a computer program/program product. The computer program/program product is stored in a storage medium, and the computer program/program product is executed by at least one processor to implement each process of the foregoing monitoring method embodiments, with the same technical effects achieved. To avoid repetition, details are not described herein again.

An embodiment of this application further provides a communication system including a terminal and a network-side device. The terminal may be configured to execute the steps of the monitoring method executed by the terminal, and the network-side device may be configured to execute the steps of the monitoring method executed by the network-side device.

It should be noted that in this specification, the terms “include”, “comprise”, or any of their variants are intended to cover a non-exclusive inclusion, such that a process, method, article, or apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. Furthermore, it should be noted that the scope of the methods and apparatuses in the embodiments of this application is not limited to performing the functions in the order shown or discussed, but may also include performing the functions in a substantially simultaneous manner or in a reverse order depending on the functions involved. For example, the described methods may be performed in an order different from the order described, and various steps may be added, omitted, or combined. In addition, features described with reference to some examples may be combined in other examples.

By means of the foregoing description of the implementations, persons skilled in the art may clearly understand that the method in the foregoing embodiment may be implemented by software with a necessary general hardware platform. In some embodiments, the method in the foregoing embodiment may also be implemented by hardware. Based on such an understanding, the technical solutions of the present application essentially or the part contributing to the prior art may be implemented in a form of a software product. The software product is stored in a storage medium (such as a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing specific embodiments. The foregoing specific embodiments are merely illustrative rather than restrictive. As instructed by this application, persons of ordinary skill in the art may also develop many other manners without departing from principles of this application and the protection scope of the claims, and all such manners fall within the protection scope of this application.

What is claimed is:

1. A monitoring method, comprising:
acquiring, by a terminal, first indication information, wherein the first indication information is used for indicating whether the terminal performs wake-up signal monitoring; and
performing, by the terminal, a first behavior when the first indication information indicates that the terminal performs the wake-up signal monitoring,
wherein the first behavior comprises: wake-up signal monitoring or a second behavior, and
the second behavior comprises at least one of the following:
applying a first power saving mode;
suspending sending of a first content;
suspending receiving or monitoring of a second content;
turning on a first receiver, wherein the first receiver is configured to receive the wake-up signal; or
entering a first sleep state, wherein the terminal suspends transmission of a channel or signal in the sleep state.

2. The monitoring method according to claim 1, wherein after acquiring, by the terminal, the first indication information, the monitoring method further comprises:
performing, by the terminal, a third behavior when the first indication information indicates that the terminal does not perform the wake-up signal monitoring,
wherein the third behavior comprises: not performing the wake-up signal monitoring or a fourth behavior, wherein the fourth behavior is related to channel or signal monitoring.

3. The monitoring method according to claim 1, wherein the first power saving mode is one of at least one power saving mode configured by a network or prescribed in a protocol,
wherein different power saving modes are associated with different parameter configurations.

4. The monitoring method according to claim 1, further comprising:
performing, by the terminal, a sixth behavior when the terminal performs the wake-up signal monitoring,
wherein the sixth behavior comprises at least one of the following:
switching to a second power saving mode;
resuming or starting the sending of the first content; or
resuming or starting the receiving or monitoring of the second content.

5. The monitoring method according to claim 4, wherein the second power saving mode is one of at least one power saving mode configured by a network side or prescribed in a protocol,
wherein different power saving modes are associated with different parameter configurations.

6. The monitoring method according to claim 4, wherein performing, by the terminal, the sixth behavior comprises:
performing, by the terminal, the corresponding sixth behavior based on a type of the monitored wake-up signal.

7. The monitoring method according to claim 1, wherein
the first indication information is used for indicating whether the terminal performs the wake-up signal monitoring during a first time period; and
performing, by the terminal, the first behavior when the first indication information indicates that the terminal performs the wake-up signal monitoring comprises:
performing, by the terminal, the first behavior during the first time period when the first indication information indicates that the terminal performs the wake-up signal monitoring during the first time period.

8. The monitoring method according to claim 7, wherein the first time period is at least one of the following:
a time period indicated by the first indication information;
a non-running time period of a discontinuous reception (DRX) timer;
a DRX duration period;
a PDCCH skipping duration; or
an application time period of a first search space group,
wherein the first search space group is a search space group that is not associated with any search space.

9. The monitoring method according to claim 1, wherein a validation time or application time of the first indication information is any one of the following:
an ending time of a time unit that has received the first indication information;
a starting time of a time unit following the time unit that has received the first indication information; or
an ending time of a first time interval starting from the ending time of the time unit that has received the first indication information,
wherein the first time interval is prescribed in a protocol or configured by a network-side device.

10. The monitoring method according to claim 1, wherein performing, by the terminal, the wake-up signal monitoring comprises:
performing, by the terminal, the wake-up signal monitoring on a first type of time unit,
wherein the first type of time unit comprises at least one of the following:
a downlink time unit, a semi-static downlink time unit, a flexible time unit, a special time unit, an uplink time unit, or a semi-static uplink time unit.

11. The monitoring method according to claim 1, wherein turning on the first receiver comprises any one of the following:
turning on the first receiver at an ending time of a time unit that has received the first indication information;
turning on the first receiver at a starting time of a time unit following the time unit that has received the first indication information; or
turning on the first receiver at an ending time of a second time interval starting from the ending time of the time unit that has received the first indication information,
wherein the second time interval is prescribed in a protocol or configured by a network-side device.

12. The monitoring method according to claim 1, further comprising:
the terminal does not expect to receive a first PDCCH after receiving the first indication information and before turning on the first receiver.

13. The monitoring method according to claim 1, wherein:
the first content comprises at least one of the following:
a scheduling request (SR), a buffer status report (BSR), a configured grant (CG), a HARQ-ACK, a physical random access channel (PRACH), a message A, a message 3, a CSI report, or a sounding reference signal (SRS); and
the second content comprises at least one of the following:
a first synchronization signal and PBCH block SSB, a first channel state information reference signal (CSI-RS), a semi-persistent scheduling physical downlink shared channel (SPS PDSCH), or a first PDCCH.

14. A monitoring method, comprising:
sending, by a network-side device, first indication information,
wherein the first indication information is used for indicating whether the terminal performs wake-up signal monitoring.

15. The monitoring method according to claim 14, wherein the first indication information is further used for indicating that the terminal performs a fifth behavior, wherein the fifth behavior is related to channel or signal monitoring.

16. The monitoring method according to claim 14, wherein the first indication information is further used for indicating a type of the wake-up signal monitored by the terminal.

17. The monitoring method according to claim 14, wherein the first indication information is used for indicating whether the terminal performs the wake-up signal monitoring during a first time period,
wherein the first time period is at least one of the following:
a time period indicated by the first indication information;
a non-running time period of a DRX timer;
a DRX duration period;
a PDCCH skipping duration; or
an application time period of a first search space group,
wherein the first search space group is a search space group that is not associated with any search space.

18. The monitoring method according to claim 14, wherein a validation time or application time of the first indication information is any one of the following:
an ending time of a time unit that has received the first indication information;
a starting time of a time unit following the time unit that has received the first indication information; or
an ending time of a first time interval starting from the ending time of the time unit that has received the first indication information,
wherein the first time interval is prescribed in a protocol or configured by the network-side device.

19. A terminal, comprising: a memory storing a computer program; and a processor coupled to the memory and configured to execute the computer program to perform operations comprising:
acquiring, by the terminal, first indication information, wherein the first indication information is used for indicating whether the terminal performs wake-up signal monitoring; and
performing, by the terminal, a first behavior when the first indication information indicates that the terminal performs the wake-up signal monitoring,
wherein the first behavior comprises: wake-up signal monitoring or a second behavior, and
the second behavior comprises at least one of the following:
applying a first power saving mode;
suspending sending of a first content;
suspending receiving or monitoring of a second content;
turning on a first receiver, wherein the first receiver is configured to receive the wake-up signal; or
entering a first sleep state, wherein the terminal suspends transmission of a channel or signal in the sleep state.

20. A network-side device, comprising: a memory storing a computer program; and a processor coupled to the memory and configured to execute the computer program to perform the monitoring method according to claim 14.
